(19) United States
(12) Patent Application Publication
(10) Pub. No.: US 2006/0182430 A1
(43) Pub. Date: Aug. 17, 2006

(54) Camera exposure program coupled to image stabilization capability

(76) Inventors: Donald J. Stavely, Windsor, CO (US); Andrew C. Goris, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/058,982

(22) Filed: Feb. 15, 2005

(51) Int. Cl. G03B 7/00; G03B 17/00

(52) U.S. Cl. 396/52; 396/243

(57) ABSTRACT

A camera selects different photographic settings when image stabilization is enabled than when image stabilization is not enabled. Preferably, for a particular photographic mode, a set of at least two separate exposure program tables is provided, a different table being used when image stabilization is enabled than when image stabilization is not enabled.

### FIELD OF THE INVENTION

The present invention relates generally to photography, and more specifically to exposure programs.

### BACKGROUND OF THE INVENTION

Many modern cameras include an automatic exposure capability. Typically, an automatic exposure system measures the brightness of a scene being photographed, and chooses camera settings for taking a particular photograph, taking into account the sensitivity of the camera's film (in the case that the camera is a film camera) or sensor (in the case that the camera is a digital camera). The settings to be chosen may include, for example, the length of time that the film or sensor should be exposed to light from the scene (the exposure time), the size of the lens aperture used during the exposure, and whether to use supplemental flash or strobe illumination. If the camera is a digital camera, the settings may also include a gain to be applied to signals or digital values that represent a digital photograph. This gain may be thought of as changing the sensitivity of the camera's sensor.

The scene brightness may be described by a brightness value (BV), which is defined as the base two logarithm of the scene luminance, measured in foot-Lamberts. For a particular scene brightness, there may be many choices of camera settings that could produce a properly-exposed photograph. For example, for taking a photograph of a subject in shade using ISO 100 film or an equivalent digital sensor sensitivity, any of the exposure time and aperture size combinations shown in Table 1 below may result in a properly-exposed photograph, and other combinations are possible as well. The aperture size is given as a fraction of the lens focal length f.

TABLE 1
Equivalent exposure combinations

| Exposure time | |
|---|---|
| (sec) | Aperture size |
| ½ | f/16 |
| ¼ | f/11 |
| ⅛ | f/8 |
| 1/15 | f/5.6 |
| 1/30 | f/4 |
| 1/60 | f/2.8 |
| 1/125 | f/2 |

The set of rules a camera uses to choose among setting combinations is sometimes called an exposure program. The camera may have a separate exposure program for each of several mode settings. For example, a camera may have a “landscape” mode wherein it chooses settings appropriate for photographic subjects that are distant and stationary, and may have a “portrait” mode wherein it chooses settings appropriate for taking portraits of people. Other modes are often included as well. The settings may be stored in a set of exposure program tables.

### BRIEF DESCRIPTION OF THE DRAWINGS

FIG. 1 shows a simplified block diagram of a digital camera in accordance with an example embodiment of the invention.

FIG. 2 depicts a flowchart of a method in accordance with an example embodiment of the invention.

FIG. 3 depicts a flowchart of a method in accordance with another example embodiment of the invention, in which an exposure program is selected based on both the state of the camera's image stabilization capability and on the photographic mode.

FIG. 4 depicts a flowchart of a method in accordance with another example embodiment of the invention, in which at least one photographic setting value is automatically selected based on the state of an image stabilization capability.

### DETAILED DESCRIPTION

An abbreviated example exposure program table for an example “point and shoot” digital camera set in a “landscape” mode is shown in Table 2 below. In constructing Table 2, it was assumed that the camera had no image stabilization capability. An exposure program table contains photograph setting values used to implement a particular exposure program. Entries in Table 2 are indexed by the scene brightness value BV. That is, entries are located in the table with reference to the scene brightness value. In taking a photograph, the example camera measures BV, and then selects camera settings from the appropriate exposure program table for the photographic mode the camera is in at the time.

TABLE 2
Example landscape mode exposure program
table, no image stabilization

| Scene | | | | |
|---|---|---|---|---|
| Brightness | | Exposure | ISO | |
| (BV) | Aperture | Time (sec) | Rating | Flash |
| −1 | f/2.8 | ⅛ | 400 | No |
| 0 | f/2.8 | 1/15 | 400 | No |
| 1 | f/2.8 | 1/30 | 400 | No |
| 2 | f/2.8 | 1/60 | 400 | No |
| 3 | f/2.8 | 1/60 | 200 | No |
| 4 | f/4.0 | 1/60 | 200 | No |
| 5 | f/4.0 | 1/60 | 100 | No |
| 6 | f/5.6 | 1/60 | 100 | No |
| 7 | f/8.0 | 1/60 | 100 | No |
| 8 | f/11 | 1/60 | 100 | No |
| 9 | f/16 | 1/60 | 100 | No |
| 10 | f/16 | 1/125 | 100 | No |
| 11 | f/16 | 1/125 | 50 | No |

Table 2 reflects several decisions made by the designer of the camera. Because this is a “point and shoot” camera likely to be used by a casual photographer, the exposure settings are chosen so that, whenever possible, the exposure time is sufficiently short to enable the camera to take a relatively sharp photograph even though the camera is handheld. In this example, it is assumed that an exposure time of 1/60 second accomplishes this goal. Because this is a table for a landscape mode, the settings are chosen to maximize the depth of field in the resulting photograph. That is, the smallest lens aperture that enables handheld operation is chosen. Because landscape subjects are likely to be far away from the camera, the table indicates that flash illumination is not to be used to supplement the ambient illumination, on the assumption that the flash would be ineffective on distant subjects. And finally, a gain factor, given in units of an equivalent film ISO rating, is chosen to further the goals of providing satisfactory handheld camera operation with maximum depth of field, while giving priority to lower gain values in order to minimize image noise in the resulting photograph. For example, for a BV of 6, the designer could have chosen an exposure time of 1/125 second with an aperture of f/4.0, but instead chose a combination with a smaller lens aperture so as to maximize depth of field, since an exposure time of 1/60 second was apparently judged fast enough to enable handholding of the camera. Similarly, for a BV of 2, the designer could have chosen an exposure time of 1/30 second and an ISO rating of 200, but instead chose a combination with a shorter exposure time so as to minimize image blur due to camera shake, at the expense of additional image noise due to the higher gain setting.

The camera may use a different exposure program table when set to a “portrait” mode. For example, the table of Table 3 below may be used.

TABLE 3
Example portrait mode exposure program
table, no image stabilization

| Scene | | | | |
|---|---|---|---|---|
| Brightness | | Exposure | ISO | |
| (BV) | Aperture | Time (sec) | Rating | Flash |
| −1 | f/2.8 | 1/60 | 400 | Yes |
| 0 | f/2.8 | 1/60 | 400 | Yes |
| 1 | f/2.8 | 1/60 | 200 | Yes |
| 2 | f/2.8 | 1/60 | 200 | Yes |
| 3 | f/2.8 | 1/60 | 200 | No |
| 4 | f/2.8 | 1/60 | 100 | No |
| 5 | f/2.8 | 1/125 | 100 | No |
| 6 | f/2.8 | 1/250 | 100 | No |
| 7 | f/2.8 | 1/500 | 100 | No |
| 8 | f/2.8 | 1/1000 | 100 | No |
| 9 | f/2.8 | 1/2000 | 100 | No |
| 10 | f/2.8 | 1/2000 | 50 | No |
| 11 | f/4.0 | 1/2000 | 50 | No |

Table 3 also reflects several decisions made by the camera's designer. Again, the settings are chosen so that the exposure time is short enough that the camera can be reliably handheld. Because this is a table to be used when photographic subjects are likely to be relatively close to the camera, supplemental flash illumination is likely to be effective and is enabled for darker scenes so that a relatively short exposure time can be maintained. For brighter scenes, settings are chosen so that the depth of field in the resulting photograph is minimized. In general, this means giving preference to using a large lens aperture whenever possible. For example, for a BV of 5, the designer could have selected an exposure time of 1/60 second and a lens aperture of f/4.0, but instead chose a combination with a larger lens aperture. Similarly, for very bright scenes, the designer has chosen to control exposure using short exposure times and low ISO ratings rather than reducing the lens aperture size. At a BV of 11, it becomes necessary (for this hypothetical example camera) to reduce the lens aperture to f/4.0 because the shortest exposure time and lowest ISO rating are already in use.

A camera constructed in accordance with an example embodiment of the invention comprises an image stabilization capability, and selects different exposure program for use when the image stabilization capability is enabled than is selected when the image stabilization capability is disabled. Preferably, the settings for each exposure program are stored in an exposure program table, and at least two exposure program tables are provided for each mode—one table for use when image stabilization is enabled, and another for use when image stabilization is disabled.

An image stabilization capability helps prevent image artifacts that are the result of unwanted camera motion. Camera pitch and yaw rotations that occur during a photographic exposure can result in a blurred photograph, because the motion causes light from a particular scene location to “smear” across a range of locations on the camera's film or sensor. Such motions often occur when the camera is handheld. Typically, in an image stabilization system, the camera's pitch and yaw rotations are sensed and an optical element in the camera is moved so as to counter the effect of the rotations, so that light from a particular scene location reaches substantially the same location on the camera's film or sensor during the entire photographic exposure. The moving optical element may be a lens element, the sensor in a digital camera, or some other optical element. In a camera in accordance with an example embodiment of the invention, the image stabilization capability can be disabled or enabled.

An image stabilization capability, when enabled, allows a photographer to handhold the camera and to reliably take unblurred photographs with longer exposure times than would be possible without the image stabilization system. A well-known rule of thumb for photographers using conventional 35-millimeter film states that the longest exposure time, measured in seconds, for which an unblurred photograph is likely using a handheld camera, is the reciprocal of the lens focal length, measured in millimeters. For example, using a lens with a focal length of 60 millimeters, a photographer is advised not to handhold the camera for any photograph with an exposure time of more than 1/60 second. An image stabilization system may extend the range of exposure times for which handholding is reliable by two to three photographic “stops”. Each factor or two change in exposure time represents one stop, so an image stabilization system may allow handheld photography with exposure times four to eight times as long as when the image stabilization system is not used.

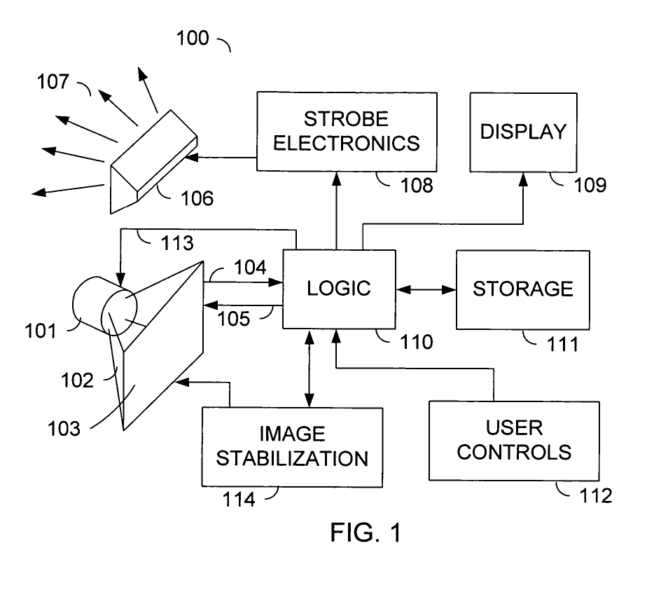

FIG. 1 shows a simplified block diagram of a digital camera 100 in accordance with an example embodiment of the invention. A lens 101 gathers light emanating from a scene, and redirects the light 102 such that an image of the scene is projected onto an electronic array light sensor 103. Electronic array light sensor 103 may be an array of charge coupled devices, commonly called a “CCD array”, a “CCD sensor”, or simply a “CCD”. Alternatively, electronic array light sensor 103 may be an array of active pixels constructed using complementary metal oxide semiconductor technology. Such a sensor may be called an “active pixel array sensor”, a “CMOS sensor”, or another similar name. Other sensor technologies are possible. The light-sensitive elements on electronic array light sensor 103 are generally arranged in an ordered rectangular array, so that each element, or “pixel”, corresponds to a scene location.

Image data signals 104 are passed to logic 110. Logic 110 interprets the image data signals 104, converting them to a numerical representation, called a “digital image.” A digital image is an ordered array of numerical values that represent the brightness or color or both of corresponding locations in a scene or picture. Logic 110 may perform other functions as well, such as analyzing digital images taken by the camera for proper exposure, adjusting camera settings, performing digital manipulations on digital images, managing the storage, retrieval, and display of digital images, accepting inputs from a user of the camera, and other functions. Logic 110 also controls electronic array light sensor 103 through control signals 105. Logic 110 may comprise a microprocessor, a digital signal processor, dedicated logic, or a combination of these.

Storage 111 comprises memory for storing digital images taken by the camera, as well as camera setting information, program instructions for logic 110, and other items. User controls 112 enable a user of the camera to configure and operate the camera, and may comprise buttons, dials, switches, or other control devices. A display 109 may be provided for displaying digital images taken by the camera, as well as for use in conjunction with user controls 112 in the camera's user interface. A flash or strobe light 106 may provide supplemental light 107 to the scene, under control of strobe electronics 108, which are in turn controlled by logic 110. Logic 110 may also provide control signals 113 to control lens 101. For example, logic 110 may adjust the focus of the lens 101, and, if lens 101 is a zoom lens, may control the zoom position of lens 101.

Image stabilization block 114 actuates sensor 103 in response to camera motions, and is in turn controlled by logic 110. Image stabilization block 114 receives control information from logic 110, and may communicate status information or other data to logic 110.

While example camera 100 is a digital camera and accomplishes image stabilization by moving its sensor in relation to its lens, one of skill in the art will recognize that the invention may be embodied in cameras of other types as well. For example, a camera in accordance with an example embodiment of the invention may be a film camera. Similarly, a camera in accordance with an example embodiment of the invention may accomplish image stabilization by moving a lens element, or by another method.

In a preferred embodiment, a user of camera 100 uses one of user controls 112 to enable or disable image stabilization as performed by image stabilization block 114. Logic 110 detects whether image stabilization is enabled or disabled, and selects an exposure program from a set of available exposure programs based on the indication. Additionally, the camera user may use one of user controls 112 to select a photographic mode, such as a landscape, portrait, or action mode. Logic 110 may detect which mode has been selected, and selects an exposure program based on the mode indication.

In a preferred embodiment, the exposure programs are described in exposure program tables, stored in storage 111. For example, storage 111 may contain two exposure program tables for each photographic mode, one for use when image stabilization is enabled and one for use when image stabilization is disabled.

For the purposes of this disclosure, a selected item, such as an exposure program or photographic setting value, is selected “based on” an underlying indicator, such as a photographic mode indication or a scene brightness, when the underlying indicator is part of the selection criteria for the selected item. Often, but not always, a first value for the underlying indicator results in a first value for the selected item, and a second value for the underlying indicator results in a second value for the selected item. A selected item may be selected based on more than one underlying indicator. For example, an exposure program table may be selected based on the state of the camera's image stabilization capability and a mode setting, while a particular photographic setting value may be chosen from the exposure program table based on a scene brightness.

An example exposure program table for use when image stabilization is disabled and the camera is in landscape mode was given in Table 2 above. An example of a landscape mode exposure program table for use when image stabilization is enabled is given in Table 4 below.

TABLE 4
Example landscape mode exposure program
table, with image stabilization enabled

| Scene | | | | |
|---|---|---|---|---|
| Brightness | | Exposure | ISO | |
| (BV) | Aperture | Time (sec) | Rating | Flash |
| −1 | f/2.8 | ⅛ | 400 | No |
| 0 | f/4.0 | ⅛ | 400 | No |
| 1 | f/4.0 | ⅛ | 200 | No |
| 2 | f/5.6 | ⅛ | 200 | No |
| 3 | f/5.6 | ⅛ | 100 | No |
| 4 | f/5.6 | 1/15 | 100 | No |
| 5 | f/8.0 | 1/15 | 100 | No |
| 6 | f/8.0 | 1/30 | 100 | No |
| 7 | f/8.0 | 1/60 | 100 | No |
| 8 | f/11 | 1/60 | 100 | No |
| 9 | f/16 | 1/60 | 100 | No |
| 10 | f/16 | 1/125 | 100 | No |
| 11 | f/16 | 1/125 | 50 | No |

The differences between tables for use with and without image stabilization will depend on the effectiveness of the image stabilization system on a particular camera and on the judgment of the camera designer. In constructing Table 4 for use in example camera 100, it was assumed that image stabilization system 114 can extend the usable handheld range of camera 100 by approximately 3 stops. That is, with image stabilization enabled, camera 100 can be reliably handheld for exposure times as long as about ⅛ second (as compared with 1/60 second when image stabilization was disabled). In example Table 4, the designer has chosen smaller aperture sizes for the range of brightness values from 0 to 6 than were chosen in Table 2, in order to further the goal of providing an extended depth of field in a landscape mode. The designer has relied on image stabilization system 114 to enable the corresponding exposure times to be lengthened and to minimize motion blur in resulting photographs.

The table entries for a brightness value of 4 are of particular interest. As compared with Table 2, the setting values in Table 4 show a longer exposure time, a smaller lens aperture, and a lower gain. The camera designer has chosen to use the increased flexibility provided by the image stabilization to both improve the depth of field of photographs by using a smaller lens aperture when image stabilization is enabled, and also to improve the photographic quality by using a smaller gain value so that noise in resulting photographs is reduced. Other choices for setting values are possible.

By way of further example, Table 5 below is an example exposure program table for use in a portrait mode when image stabilization is enabled.

TABLE 5
Example portrait mode exposure program
table, with image stabilization enabled

| Scene | | | | |
|---|---|---|---|---|
| Brightness | | Exposure | ISO | |
| (BV) | Aperture | Time (sec) | Rating | Flash |
| −1 | f/2.8 | ⅛ | 200 | Yes |
| 0 | f/2.8 | ⅛ | 200 | No |
| 1 | f/2.8 | ⅛ | 100 | No |
| 2 | f/2.8 | 1/15 | 100 | No |
| 3 | f/2.8 | 1/30 | 100 | No |
| 4 | f/2.8 | 1/60 | 100 | No |
| 5 | f/2.8 | 1/125 | 100 | No |
| 6 | f/2.8 | 1/250 | 100 | No |
| 7 | f/2.8 | 1/500 | 100 | No |
| 8 | f/2.8 | 1/1000 | 100 | No |
| 9 | f/2.8 | 1/2000 | 100 | No |
| 10 | f/2.8 | 1/2000 | 50 | No |
| 11 | f/4.0 | 1/2000 | 50 | No |

As compared with Table 3 above, in Table 5 the camera designer has taken advantage of the increased range of scene brightness for which the camera may be reliably handheld to provide gain settings that will result in improved image noise for relatively dark scenes. Additionally, the designer has extended the range of conditions under which photographs will be taken without enabling the camera's flash or strobe illumination. Other setting combinations are possible as well.

As is described in the above examples, values for one or more photographic settings may be selected based on the state (enabled or disabled) of the camera's image stabilization capability. The settings for which values are selected may include an exposure time, an aperture size, a gain, whether to use supplemental flash illumination, or other settings, either singly or in any combination.

In accordance with another example embodiment of the invention, lens 101 of camera 100 is a zoom lens, and camera 100 detects whether image stabilization capability 114 is enabled, detects the focal length of lens 101, and automatically selects a value for one or more photographic settings based on the lens focal length and the state of the image stabilization capability. For the purposes of this disclosure, detecting a lens focal length may be accomplished by reading a sensor such as a potentiometer or encoder that is responsive to the lens focal length. Alternatively, the focal length of lens 101 may be detected by keeping track of the commanded focal length or by keeping track of the commanded positions of one or more elements of lens 101, for example when the lens focal length is adjusted by logic 110 in response to user controls 112.

Tables 6 and 7 below are example landscape mode exposure program tables that may be used when the camera's lens is set to a longer focal length than was assumed for tables 2 and 4 above. Table 6 is designed for use when image stabilization is disabled, and Table 7 is designed for use when image stabilization is enabled. It is assumed that an exposure time of 1/125 second is sufficiently fast to allow handholding of the camera when image stabilization is not in use. Where possible, the camera designer has chosen table entries that keep the exposure time at 1/125 second or less to enable handheld operation of the camera, and has chosen aperture and gain settings that tend to maximize depth of field in the resulting photographs.

TABLE 6
Example landscape mode exposure program table, no image
stabilization, focal length = 125 mm equivalent

| Scene | | | | |
|---|---|---|---|---|
| Brightness | | Exposure | ISO | |
| (BV) | Aperture | Time (sec) | Rating | Flash |
| −1 | f/2.8 | ⅛ | 400 | No |
| 0 | f/2.8 | 1/15 | 400 | No |
| 1 | f/2.8 | 1/30 | 400 | No |
| 2 | f/2.8 | 1/60 | 400 | No |
| 3 | f/2.8 | 1/125 | 400 | No |
| 4 | f/2.8 | 1/125 | 200 | No |
| 5 | f/4.0 | 1/125 | 200 | No |
| 6 | f/4.0 | 1/125 | 100 | No |
| 7 | f/5.6 | 1/125 | 100 | No |
| 8 | f/8.0 | 1/125 | 100 | No |
| 9 | f/11 | 1/125 | 100 | No |
| 10 | f/11 | 1/250 | 100 | No |
| 11 | f/16 | 1/250 | 100 | No |

In Table 7, image stabilization allows the designer to maintain smaller lens aperture settings and/or lower gain settings for darker scenes, as compared with the settings in Table 6. It is assumed that the image stabilization extends the reliable handheld range by about three photographic stops, so that the camera can be handheld with exposure times as long as about 1/15 second.

TABLE 7
Example landscape mode exposure program table, with image
stabilization enabled, focal length 125 mm equivalent

| Scene | | | | |
|---|---|---|---|---|
| Brightness | | Exposure | ISO | |
| (BV) | Aperture | Time (sec) | Rating | Flash |
| −1 | f/2.8 | ⅛ | 400 | No |
| 0 | f/2.8 | 1/15 | 400 | No |
| 1 | f/2.8 | 1/15 | 200 | No |
| 2 | f/4.0 | 1/15 | 200 | No |
| 3 | f/4.0 | 1/15 | 100 | No |
| 4 | f/4.0 | 1/30 | 100 | No |
| 5 | f/5.6 | 1/30 | 100 | No |
| 6 | f/8.0 | 1/30 | 100 | No |
| 7 | f/11 | 1/30 | 100 | No |
| 8 | f/11 | 1/60 | 100 | No |
| 9 | f/11 | 1/125 | 100 | No |
| 10 | f/11 | 1/250 | 100 | No |
| 11 | f/16 | 1/250 | 100 | No |

When Tables 2, 4, 6, and 7 are used in concert, an exposure program or exposure program table c an be chosen based on the current photographic mode, or based on whether image stabilization is enabled or disabled, or based on the lens focal length, or on any combination of these underlying indicators. A particular photographic setting value, such as an exposure time, is selected based on the current photographic mode, or based on whether image stabilization is enabled or disabled, or based on the lens focal length, or based on the scene brightness, or on any combination of these.

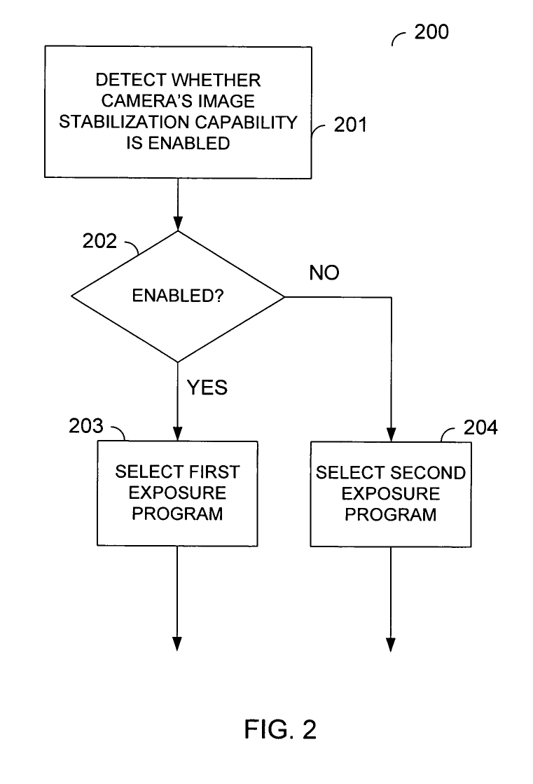

FIG. 2 depicts a flowchart 200 of a method in accordance with an example embodiment of the invention. At step 201, the current state of a camera's image stabilization capability is detected. At decision block 202, a decision is made depending on the state of the image stabilization capability. If the capability is enabled, control passes to block 203, where a first exposure program is selected. If the capability is not selected, control passes to block 204, where a second exposure program is selected.

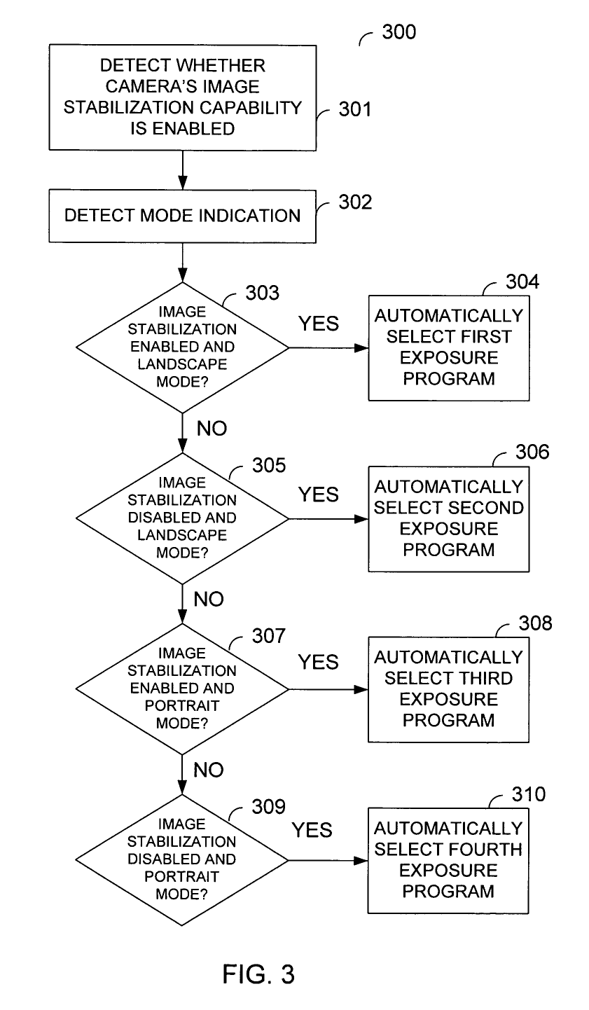

FIG. 3 depicts a flowchart 300 of a method in accordance with another example embodiment of the invention, in which an exposure program is selected based on both the state of the camera's image stabilization capability and on the photographic mode. In step 301, the state of the image stabilization capability is detected. In step 302, an indication of a photographic mode is detected. At step 303, if image stabilization is enabled and a landscape mode has been selected, control passes to step 304 where a first exposure program is automatically selected. Otherwise, control passes to step 305. At step 305, if image stabilization is disabled and the camera is in a landscape mode, control passes to step 306 where a second exposure program is automatically selected. Otherwise, control passes to step 307. At step 307, if image stabilization is disabled and the camera is in a portrait mode, control passes to step 308 where a third exposure program is automatically selected. Otherwise, control passes to step 309. At step 309, if image stabilization is disabled and the camera is in a portrait mode, control passes to step 310 where a second exposure program is automatically selected. The flowchart of FIG. 3 may be expanded as needed to accommodate other photographic modes, or to include other underlying indicators, based upon which an exposure program may be selected.

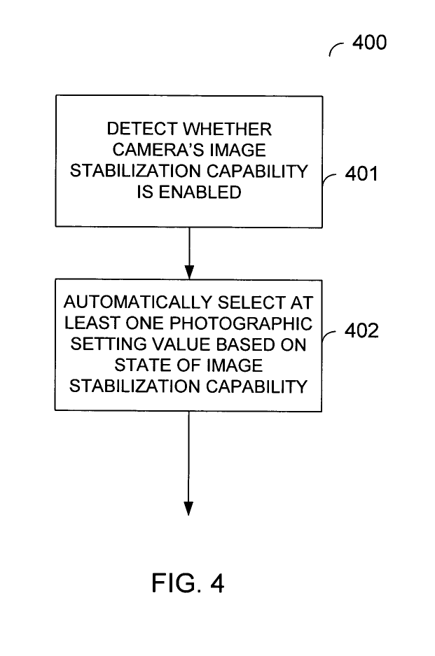

FIG. 4 depicts a flowchart 400 of a method in accordance with another example embodiment of the invention, in which at least one photographic setting value is automatically selected based on the state of an image stabilization capability. At step 401, the state of the image stabilization capability, whether enabled or disabled, is detected. At step 402, at least one photographic setting value is automatically selected based on the detected state.

1. A method, comprising:
detecting whether an image stabilization capability of a camera is enabled;
automatically selecting a first exposure program for use by the camera when the image stabilization capability is enabled; and
automatically selecting a second exposure program for use by the camera when the image stabilization capability is disabled.

2. The method of claim 1, further comprising:
detecting a photographic mode indication; and
automatically selecting the exposure program based on the photographic mode indication.

3. The method of claim 1, further comprising selecting at least one camera setting value from an exposure program table stored in the camera.

4. The method of claim 3, further comprising:
measuring a scene characteristic; and
locating the camera setting value in the exposure program table based on the scene characteristic measurement.

5. The method of claim 4, wherein the scene characteristic is a brightness of the scene.

6. A method of camera operation, comprising:
detecting whether an image stabilization capability of the camera is enabled; and
automatically selecting, based on the state of the image stabilization capability, at least one photographic setting value.

7. The method of claim 6, wherein the photographic setting is one of an exposure time, an aperture size, and a gain.

8. The method of claim 6, further comprising:
evaluating a scene; and
automatically selecting the photographic setting value based on the scene evaluation.

9. The method of claim 8, wherein evaluating the scene comprises measuring a brightness of the scene.

10. A method of camera operation, comprising:
detecting whether an image stabilization capability of the camera is enabled; and
automatically selecting a combination of exposure time and aperture size based on the state of the image stabilization capability.

11. The method of claim 10, further comprising:
evaluating a scene; and
automatically selecting the combination of exposure time and aperture size based on the scene evaluation.

12. The method of claim 11, wherein evaluating the scene comprises measuring a brightness of the scene.

13. A method of camera operation, comprising:
detecting whether an image stabilization capability of the camera is enabled; and
automatically selecting a combination of exposure time and gain based on the state of the image stabilization capability.

14. The method of claim 13, further comprising:
evaluating a scene; and
automatically selecting the combination of exposure time and gain based on the scene evaluation.

15. The method of claim 14, wherein evaluating the scene comprises measuring a brightness of the scene.

16. A method of camera operation, comprising:
detecting whether an image stabilization capability of the camera is enabled; and
automatically selecting a combination of gain and aperture size based on the state of the image stabilization capability.

17. The method of claim 16, further comprising:
evaluating a scene; and
automatically selecting the combination of gain and aperture size based on the scene evaluation.

18. The method of claim 17, wherein evaluating the scene comprises measuring a brightness of the scene.

19. A method of camera operation, comprising:
detecting whether an image stabilization capability of the camera is enabled; and
automatically selecting a combination of exposure time, aperture size, and gain based on the state of the image stabilization capability.

20. The method of claim 19, further comprising:
evaluating a scene; and
automatically selecting the combination of exposure time, aperture size, and gain based on the scene evaluation.

21. The method of claim 20, wherein evaluating the scene comprises measuring a brightness of the scene.

22. A method of camera operation, comprising:
detecting whether an image stabilization capability of the camera is enabled; and
automatically deciding, based in the state of the image stabilization capability, whether to use flash illumination in taking a photograph.

23. The method of claim 22, further comprising:
evaluating a scene; and
automatically deciding, based on the scene evaluation, whether to use flash illumination in taking a photograph.

24. The method of claim 23, wherein evaluating the scene comprises measuring a brightness of the scene.

25. A method of camera operation, comprising:
detecting whether an image stabilization capability of the camera is enabled; and
automatically, based on the state of the image stabilization capability, selecting a combination of exposure time, aperture size, and gain, and deciding whether to use flash illumination in taking a photograph.

26. The method of claim 25, further comprising:
evaluating a scene; and
automatically, based on the scene evaluation, selecting the combination of exposure time, aperture size, and gain, and deciding whether to use flash illumination in taking a photograph.

27. The method of claim 26, wherein evaluating the scene comprises measuring a brightness of the scene.

28. A method of camera operation, comprising:
detecting a photographic mode indication;
detecting whether an image stabilization capability of the camera is enabled;
evaluating a scene; and
automatically selecting the value of at least one camera setting value from an exposure program table, the exposure program table chosen from a set of available exposure program tables based on the photographic mode indication and the state of the image stabilization capability, and the camera setting value selected from the exposure program table based on the result of the scene evaluation.

29. A method of camera operation, comprising:
detecting whether an image stabilization capability of the camera is enabled;
detecting a lens focal length; and
automatically selecting, based on the state of the image stabilization capability and the lens focal length, an exposure program.

30. A method of camera operation, comprising:
detecting whether an image stabilization capability of the camera is enabled;
detecting a lens focal length; and
automatically selecting, based on the state of the image stabilization capability and the lens focal length, a value for one or more photographic settings.

31. The method of claim 30, wherein the photographic setting or settings are selected from a set of photographic settings consisting of an exposure time, an aperture size, a gain, and whether to use flash illumination in taking a photograph.

32. A camera, comprising:
an image stabilization capability that can be enabled and disabled;
logic configured to detect the state of the image stabilization capability and to automatically select an exposure program based on the state.

33. The camera of claim 32, wherein the logic is further configured to detect a photographic mode indication and automatically select an exposure program based on the mode indication.

34. The camera of claim 33, further comprising storage holding at least one exposure program table for each state, each exposure program table comprising photographic setting values for implementing an exposure program.

35. The camera of claim 34, wherein entries in each exposure program table are indexed by a scene brightness value.

36. The camera of claim 32, wherein the camera is a film camera.

37. The camera of claim 32, wherein the camera is a digital camera.

38. A camera, comprising
an image stabilization capability that can be enabled and disabled; and
logic configured to detect the state of the image stabilization capability and automatically select at least one photographic setting value based on the state.

39. The camera of claim 38, wherein each photographic setting value automatically selected is an exposure time, an aperture size, a gain, or whether to use flash illumination in taking a photograph.

40. The camera of claim 38, wherein at least two photographic setting values are automatically selected based on the state, the automatically selected values comprising any two of the group consisting of an exposure time, an aperture size, a gain, and whether to use flash illumination in taking a photograph.

41. The camera of claim 38, wherein at least three photographic setting values are automatically selected based on the state, the automatically selected values comprising any three of the group consisting of an exposure time, an aperture size, a gain, and whether to use flash illumination in taking a photograph.

42. The camera of claim 38, wherein at least four photographic setting values are automatically selected based on the state, the automatically selected values comprising an exposure time, an aperture size, a gain, and whether to use flash illumination in taking a photograph.

43. The camera of claim 38, further configured to evaluate a scene, and wherein the logic is further configured to automatically select at least one photographic setting value based on the scene evaluation.

44. The camera of claim 43, wherein the camera is configured to evaluate the scene by measuring a brightness of the scene.

45. The camera of claim 38, wherein the camera is a film camera.

46. The camera of claim 38, wherein the camera is a digital camera.

47. A camera, comprising:
an image stabilization capability that can be enabled and disabled;
a lens settable to more than one focal length; and
logic configured to detect the state of the image stabilization capability and to detect the focal length of the lens, and further configured to automatically select an exposure program based on the state of the image stabilization capability and the lens focal length.

48. A camera, comprising:
an image stabilization capability that can be enabled and disabled;
a lens settable to more than one focal length; and
logic configured to detect the state of the image stabilization capability and to detect the focal length of the lens, and further configured to automatically select a photographic setting value based on the state of the image stabilization capability and the lens focal length.

49. A camera, comprising:
means for performing image stabilizations;
means for enabling and disabling the image stabilization means;
means for automatically selecting, based on the state of the image stabilization means, an exposure program.

50. The camera of claim 49, further comprising:
means for setting a photographic mode; and
means for automatically selecting, based on the photographic mode setting, an exposure program.

51. A camera, comprising:
means for performing image stabilizations;
means for enabling and disabling the image stabilization means;
means for automatically selecting, based on the state of the image stabilization means, a photographic setting value.
